(19) United States
(12) Patent Application Publication
(10) Pub. No.: US 2007/0190843 A1
(43) Pub. Date: Aug. 16, 2007

(54) Mechanical docking and latching system

(76) Inventors: Jody Snow, Garner, NC (US); Randy Grey Martinez, Burlington, NC (US); Craig Mason, Forest, VA (US)

Correspondence Address: JOHN L. SOTOMAYOR, 511 DAVIS DRIVE, SUITE 300, MORRISVILLE, NC, 27560, US

(21) Appl. No.: 11/354,809

(22) Filed: Feb. 16, 2006

(51) Int. Cl. H01R 13/62

(52) U.S. Cl. 439/297

(57) ABSTRACT

This invention is a scalable docking and equipment enclosure system that provides secure mechanical and electrical connectivity for mobile digital electronics equipment. The system provides for protection of connectors when the equipment unit is separated from the docking unit, proper alignment of equipment within the docking unit, protection against forceful insertion and damage of equipment, and secures mechanical latching of the equipment unit within the docking unit once the equipment unit is fully inserted.

### PRIORITY

This application claims the benefit of priority to U.S. non-provisional application Ser. No. 10/703,258 which was filed Nov. 7, 2003.

### BACKGROUND OF THE INVENTION

Equipment docking units and means for the attachment of devices that are placed within equipment mounting positions within an equipment rack are well known in the art. So, too are means and methods for the guidance of equipment when being placed into the docking unit and means for the secure electrical connection of such equipment and strain relief on any such electrical connections. This can be seen to be true in granted patents such as U.S. Pat. No. 6,052,278, which recites a latching mechanism for secure electrical connection of a device into a rack, and U.S. Pat. No. 6,392,892 which recites a simple latching pin for a locking handle to secure equipment into an equipment rack.

However, equipment docking units and the pieces of equipment that are intended to be used within such docking units are considered a conjoined unit when docking designs are implemented. No real thought is given to the equipment as a separate unit that will be removed and reinserted repeatedly, or how the equipment connections are protected in a rugged environment separate from the protection of the equipment dock itself. Protection against environmental intrusions, such as dirt or other detritus, and against impacts that will harm connector pins when the equipment unit is separated from the docking enclosure are not considered.

Another aspect of a secure docking and equipment mounting system is a docking enclosure capable of accepting a properly configured equipment unit. Existing docking enclosures do not provide a means or mechanism to accommodate an equipment unit that is configured to protect connectors attached to the equipment unit. Such existing systems also do not protect against incorrect orientation of the equipment unit when it is inserted into the docking unit, or secure electrical contact between the connector mounted within the equipment unit and a receptive connector mounted in the back wall of the equipment docking unit.

In addition, such docking and latching systems as exist in the prior art consider the system as a fixed solution, mounted to an unmoving and unmovable platform. No consideration has been given to the requirements of equipment that must be reliably inserted and removed from a docking unit that is installed within a mobile platform.

Although systems do exist with latches designed to guide an equipment unit in place as it is inserted into an equipment docking unit, no current system provides a means to lock an equipment unit in place within a docking unit and spring loaded pins to releasably secure an equipment unit handle against being accidentally dislodged from either horizontal or vertical orientations.

The instant invention presents means for proper insertion orientation and protection of equipment connectors in a rugged environment, yet still providing for repeated, secure orientation, insertion, and removal to and from an equipment docking enclosure, as well as secure mechanical and electrical connectivity for connectors within the equipment unit. The instant invention thus provides a novel, non-obvious, scalable solution for vehicle-based equipment docking systems.

### SUMMARY OF THE INVENTION

The instant invention is a docking and equipment latching system that provides a user with the ability to securely insert an appropriately equipped equipment case into a properly configured equipment docking unit secure in the knowledge that the equipment unit will be aligned correctly by the equipment docking unit and be held securely until a user action occurs to unlock and detach said equipment unit from the docking unit. In keeping with proper insertion orientation, the instant invention also prevents forceful insertion of the equipment unit into the docking unit, even if properly oriented, thus protecting against damage to the equipment unit and the connectors from overly zealous users. In addition, the instant invention provides a movable connector cover that provides protection for the electrical connector on the back side of an appropriately configured equipment unit. This cover is caused to slide up out of the way by two side-mounted equipment rails when an equipment unit is inserted into an equipment docking unit, thus revealing the connector and completing the mechanical and electrical connections between the equipment unit and the equipment docking unit. The electrical connector mounted within the equipment unit is also spring mounted to provide for alignment and protection against bumps and jostling.

The invention accomplishes the first task through a locking handle with an integral spindle and rotating cams. When open and unlocked, the locking handle is configured such that the rotating cams are in a horizontal position in line with an equipment slide mounted on the side of the equipment unit when the equipment unit is mechanically disconnected from the equipment docking unit. When the equipment unit is inserted fully into the equipment docking unit, the handle may be swiveled from a horizontal orientation to a vertical orientation, the cams swiveling to a vertical orientation in concert with the handle. A slot in each cam accommodates a pin connected to the sides of the equipment docking unit such that the pin travels along the cam slots to assist in the secure insertion of the equipment unit in the equipment docking unit, the cams being engaged only when the handle is physically moved from a locked, horizontal position. When the handle and cam reach the limit of rotational movement, the handle is fully in a vertical orientation and spring loaded cam pins, located between the exterior case of the equipment unit and the sides of the cams adjacent to the equipment unit casing, slips into a small indentation in the side of the equipment unit casing causing the cam and handle to lock into position. In addition, the spring mounted connector is fully aligned and in mechanical and electrical connection with the receptacle connector within the equipment docking unit. The position lock is maintained against accidental jarring or other incidental movement. A user must pull up on the handle with sufficient force to dislodge the spring loaded spindle from the indentation in the equipment unit, allowing the handle to be rotated from the vertical orientation to the horizontal orientation, unlocking the equipment unit and freeing the equipment unit for removal from the equipment docking unit. When the handle is fully rotated to the horizontal orientation, the cam pins snap into another set of locking depressions in the sides of the equipment unit enclosure securely locking the handle into a horizontal orientation.

This invention also provides for an innovative means for vertically moving a protective plate from a position in which the plate forms a protective cover for electrical contacts when an equipment unit is separate from the equipment docking unit, to a position that reveals the electrical connector when the equipment unit is inserted into an equipment docking unit. This protective cover plate is spring mounted such that it covers all electrical connectors on the back of the equipment unit when the equipment unit is removed from the equipment docking unit. The cover plate thus affords protection from the environment for any and all electrical connectors when the equipment unit is not inserted into, and electrically connected to, the equipment docking unit. As the equipment unit is inserted into an appropriate slot in the equipment docking unit, a chamfer in the guidance rail of the equipment docking unit raises the protective cover. The cover is raised when the equipment unit is inserted into the equipment docking such that all electrical connectors are free to establish firm electrical connectivity with the equipment docking unit.

### BRIEF DESCRIPTION OF THE DRAWINGS

The above objects and advantages of the present invention will become more apparent by describing in detail preferred embodiments thereof with reference to the attached drawings, in which:

FIG. 1: interior and exterior surface of left cam.

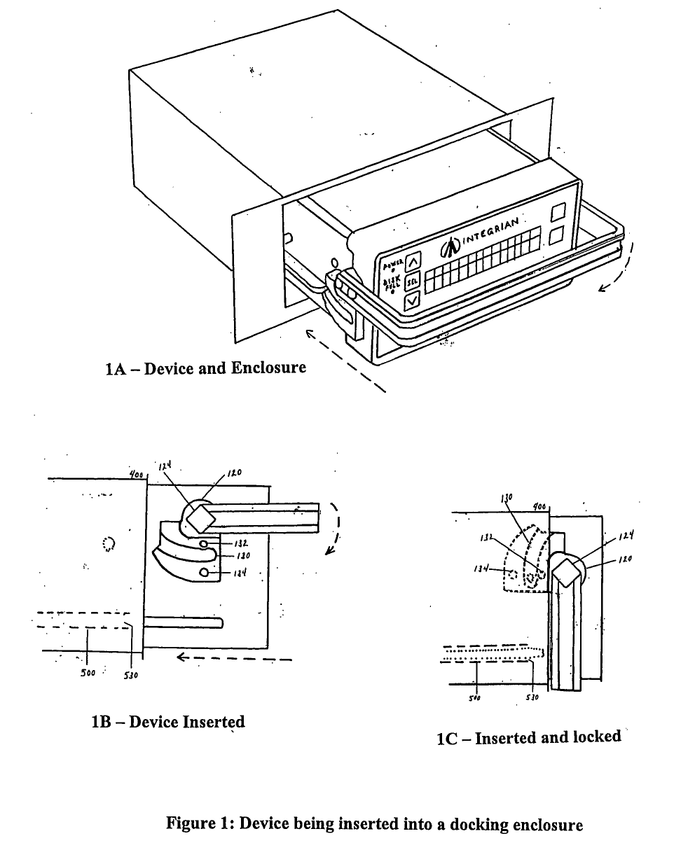

FIG. 2: connector cover detail.

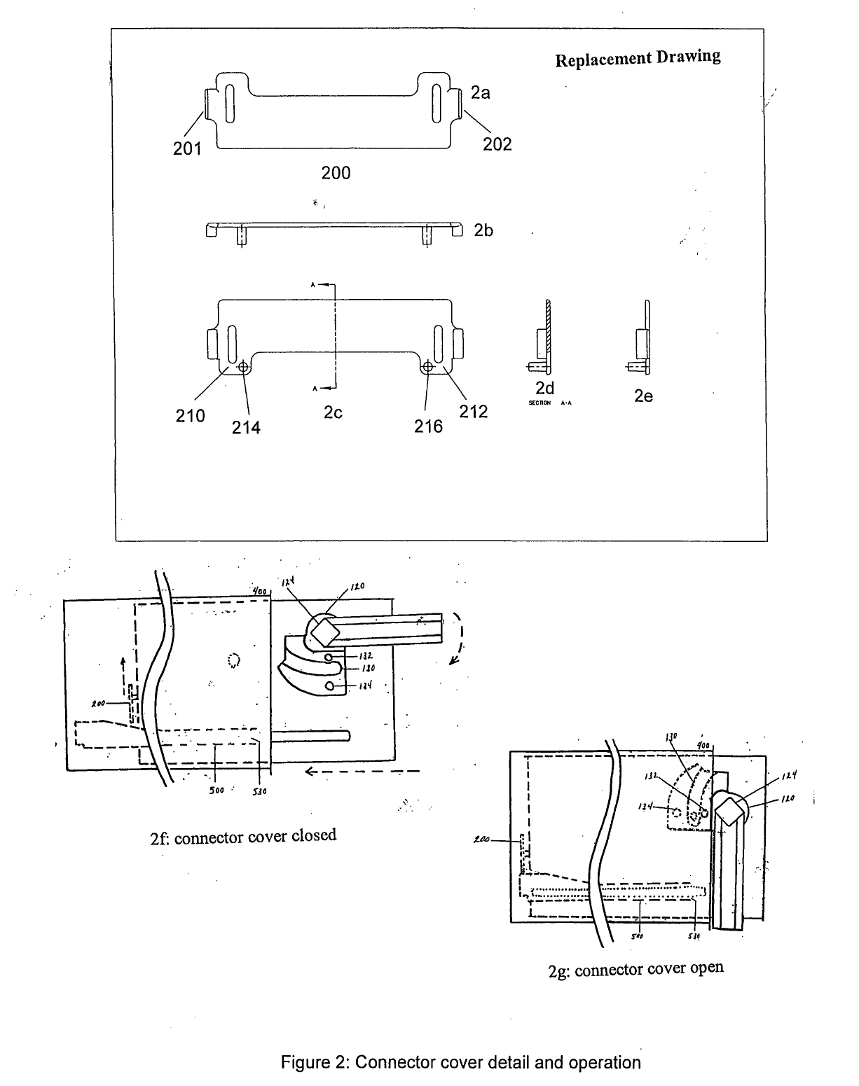

FIG. 3: cam pin detail.

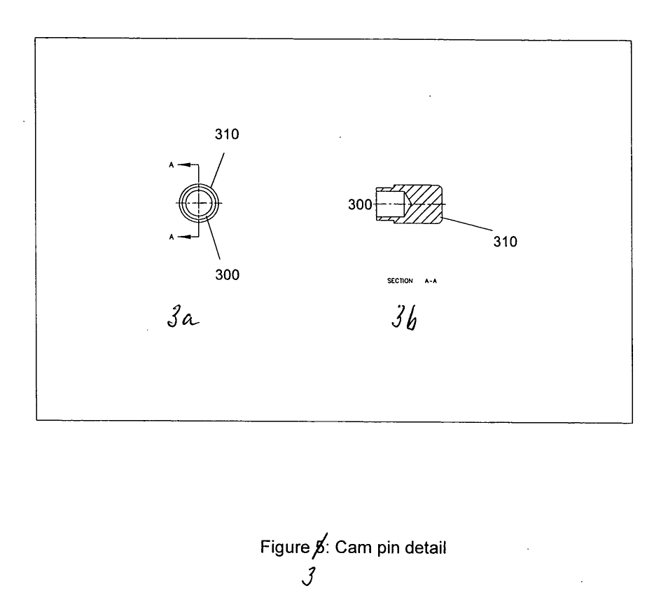

FIG. 4: Equipment docking unit and connector.

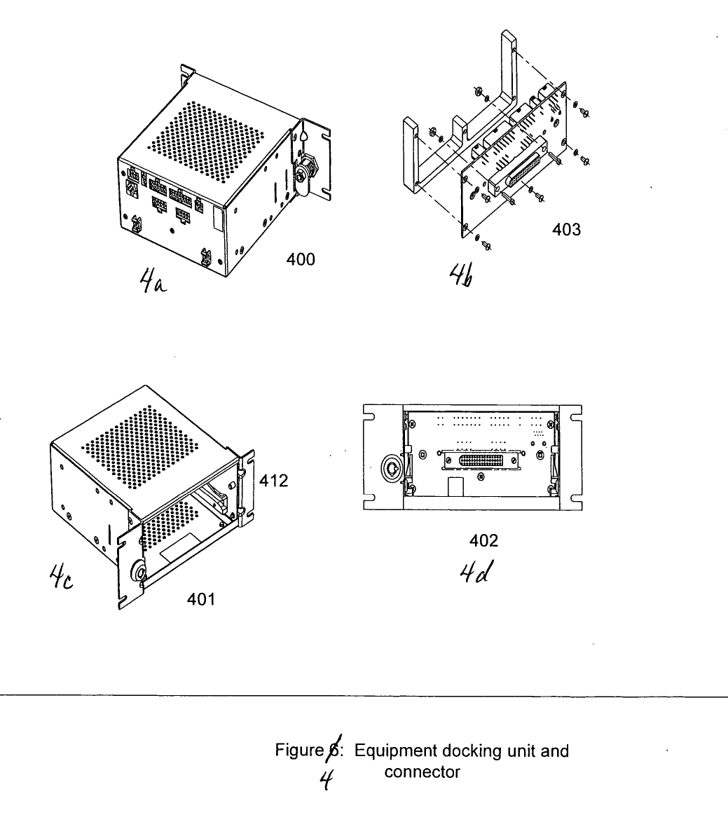

FIG. 4: equipment unit docking guide rail.

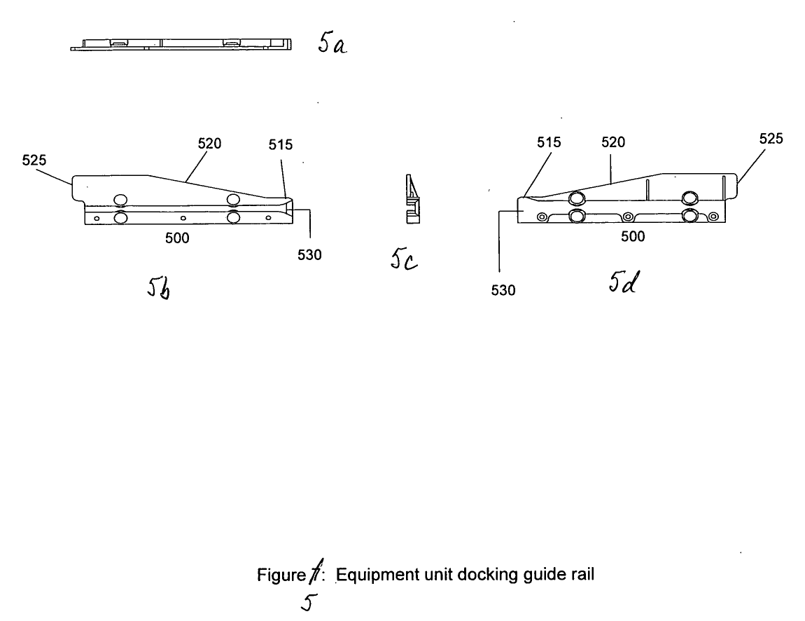

### DETAILED DESCRIPTION OF THE INVENTION

In the instant invention, an equipment device housing is installed in a docking unit 401 to serve as a mounting platform for a detachable digital video recorder device. The digital video recorder device is contained within said housing which is designed for rugged resistance against environmental hazards such as dirt and particulate matter, and for resistance to impacts, such as those from rough handling or falling on hard surfaces. Together, the equipment docking unit 401 and the detachable digital video recorder device installed within an equipment device housing form the docking mechanical system.

The docking mechanical system also features a latching handle and vertically raisable connector cover 200 for use in securing the digital video recorder device against un-desirable electrical contact disconnect and ruggedized protection for all electrical connectors that would otherwise be exposed to accidental impacts when the detachable digital video recorder device is disconnected from the equipment docking enclosure 401.

The digital video recorder device is installed in the field within an equipment docking unit 401 that is secured within a mobile platform, such as a police vehicle, bus, or train. While within the vehicle, the digital video recording device continually records an integrated data stream containing video, audio, and metadata. When the memory installed within the digital video recorder is full, or when the vehicle returns to a central location such as a garage or police station, the operator may take the opportunity to remove the digital video recorder device from the vehicle and place said device into an equipment docking enclosure 401 maintained within the garage or police station. Once inserted, a server electrically connected to the equipment docking unit downloads the contents of the memory within the digital video recording device.

The instant invention assists in the secure and consistent download of the memory contents of the digital video recorder device by ensuring the integrity of the electrical connectors located on the back surface of the digital video recorder device through the use of a connector cover 200, providing a secure mechanical and electrical connection between the digital video recorder device and the equipment docking unit 401, and protecting against accidental electrical disconnect or removal of the digital video recording device during download activities. On the interior side walls of the equipment docking unit are mounted guidance side rails 500. Each guide rail contains a slot 530 into which guidance rails fastened to the exterior side walls of an equipment unit are inserted. The front portion of each side rail 515 is installed such that the guidance rails may be inserted while the connector cover 200 is in a full coverage position over the electrical connectors in the back side of the equipment unit. The guide rails are tapered 520 from near the front of the guide rail 515 to the back of the guide rail 525. The taper 520 is sufficient to cause the electrical connector cover 200 to move from fully closed to fully open as the equipment unit slides into the equipment docking unit 401, such that as the equipment unit is fully inserted into the equipment docking unit 401 the electrical connectors on the back of the equipment unit are fully exposed and capable of completing mechanical and electrical contact with the receptacle connector 403 in the back wall of the equipment docking unit 401.

With the electrical connectors in mechanical and electrical contact with the equipment docking unit 401, a server may now establish communication over the electric communication pathway and initiate the download of the integrated data stream files stored within the equipment unit.

Ensuring the integrity of the electrical connectors installed in the back wall of the equipment unit is accomplished through the use of the electrical connector cover 200. The electrical connector cover 200 spans the width of the equipment unit with flanges (201, 202) that extend beyond each of the side walls of the equipment unit. The electrical connector cover 200 is raisably secured to the back of the equipment unit through two slots (210, 212), one in the left quarter of the electrical connector cover 200 and the second in the right quarter of the electrical connector cover 200. Springs are connected to the raisable connector cover to maintain the cover in tension when the equipment unit is fully inserted within the docking unit 401. The flanges (201, 202) are configured such that they rest upon the top of the equipment docking unit guide rails 500. As the equipment unit slides into the equipment docking unit 401, the flanges (201, 202) slide along the top of the tapered guide rails 500 causing the electrical connector cover 200 to be raised above the level of the electrical connector, exposing the electrical connector for insertion into the receptacle 403 in the back wall of the equipment docking unit 401. When the equipment unit is removed from the equipment docking unit 401, the electrical connector cover 200 once again slides along the guide rails 500, this time from the high point of the guide rail taper 525 down to the lower position of the front of the guide rails 515. When the equipment unit is removed from the docking unit 401 and the connector cover plate 200 is no longer held in a vertical raised position by the guide rails 500, the springs pull the connector cover 200 back down to a fully covered position over the connector.

The invention also protects against the accidental disconnection or dislodgement of the equipment unit during download and other activities while the equipment unit is installed within the equipment docking unit 401. This is accomplished through the use of a locking cam 100 and spring loaded pins 412 mounted on the each side of the equipment unit. The two cams have arcuate grooves 130 and are attached to the handle such that the cam 100 swivels through a 90 degree arc when the handle is pressed down from a horizontal orientation to a vertical orientation. As the cam 100 moves through the arc, cam pins 412 that are an integral portion of each side of the equipment docking unit 401 are positioned such that they traverse the arcuate groove 130 in the front surface of each cam 100. When the handle is placed in its fully vertical orientation, the cam pins 412 rests against the end of the cam grooves 130. When the handle is placed in its fully vertical orientation, two spring loaded pins 134, installed within each cam 100 and located between the surface facing the equipment unit and the side surface of the equipment unit, slip into depressions in the sides of the equipment unit placed such that the depressions and spring loaded pins 134 are aligned only when the handle is in a fully vertical or horizontal orientation. When the spring loaded pins 134 slip into the depressions in the sides of the equipment unit, the handle is held in place by the tension of the spring. Moving the handle from the vertical orientation once the spring loaded pins 134 rest within the depression in the equipment unit case requires a positive force on the handle to force the spring loaded pins 134 out of the depression and permit the movement of the handle from the full vertical orientation and back to a horizontal orientation. Similarly, the handle is locked into the horizontal orientation by two depressions located such that the spring loaded pins 134 slip into a second set of depressions when the handle is in the full horizontal orientation. Thus, simply jarring the handle or jostling the equipment unit, once the handle is in its fully vertical or fully horizontal orientation, will not unlock the handle or disrupt the connectivity between the electrical connectors of the equipment unit and the socket connectors in the equipment docking unit 401.

Through the use of the unique innovations described above, this invention provides for a secure, rugged system that is detachable and may be used within both mobile and stationary platforms without fear of damage to the equipment or loss of critical data due to unforeseen actions or activity.

While this invention has been particularly shown and described with reference to preferred embodiments thereof, it will be understood by those skilled in the art that various changes in form and details may be made therein without departing from the spirit and scope of the invention as defined by the appended claims.

We claim:

1. A mechanical docking and latching system for digital recording equipment comprising an equipment docking unit and a detachable equipment unit configured to provide secure interconnection and environmental hazard protection for the detachable equipment unit, the system comprising:
an equipment docking unit configured as a receptacle for an equipment unit with a top surface, bottom surface, left and right surfaces with integral guide rails, and a back surface with a mating connector;
an equipment unit comprising a digital video recorder configured within an equipment unit casing comprising a top surface, bottom surface, left and right surfaces with said integral slide rails, a front surface with openings for a plurality of informational displays and controls, a back surface with openings through which electrical connectors are emplaced, a slideably attached back cover plate, a pivoting handle with side cams attached to the front portion of the side surfaces, and at least two spring-loaded locking pins;
wherein said connector on the back of said equipment unit is configured to be in mechanical and electrical connection with said mating connector of said equipment docking unit when said equipment unit is fully inserted and latched within said equipment docking unit.

2. A mechanical docking and latching system as recited in claim 1 for digital recording equipment comprising an equipment docking unit and a detachable equipment unit configured to provide secure interconnection and environmental hazard protection for the detachable equipment unit, the system further comprising:
said slideably attached electrical connector cover plate attached to said back surface of the equipment unit is spring-loaded;
wherein the spring-loading comprises at least two springs affixed to said electrical connector cover plate and the interior surface of the back surface of said equipment unit.

3. A mechanical docking and latching system as recited in claim 2 for digital recording equipment comprising an equipment docking unit and a detachable equipment unit configured to provide secure interconnection and environmental hazard protection for the detachable equipment unit, the system further comprising:
wherein said springs attached to said spring-loaded electrical connector cover plate are configured to maintain tension upon said electrical connector cover plate such that said electrical connector cover plate is held in place as a covering for all connectors mounted through the back wall of said equipment unit.

4. A mechanical docking and latching system as recited in claim 1 for digital recording equipment comprising an equipment docking unit and a detachable equipment unit configured to provide secure interconnection and environmental hazard protection for the detachable equipment unit, the system further comprising:
said pivoting handle configured to swivel from a horizontal orientation through 90 degrees to a vertical orientation.

5. A mechanical docking and latching system as recited in claim 1 for digital recording equipment comprising an equipment docking unit and a detachable equipment unit configured to provide secure interconnection and environmental hazard protection for the detachable equipment unit, the system further comprising:
at least two cams, one mechanically connected to the left end of the handle and one mechanically connected to the right end of the handle, between the handle ends and the left surface and right surface of the casing of said equipment unit.

6. A mechanical docking and latching system as recited in claim 5 for digital recording equipment comprising an equipment docking unit and a detachable equipment unit configured to provide secure interconnection and environmental hazard protection for the detachable equipment unit, the system further comprising:
said cams further comprising an arcuate groove in the exterior surface facing away from the equipment unit of each cam and configured to accept pins extending from the interior of the left surface and the interior of the right surface of the equipment docking unit.

7. A mechanical docking and latching system as recited in claim 6 for digital recording equipment comprising an equipment docking unit and a detachable equipment unit configured to provide secure interconnection and environmental hazard protection for the detachable equipment unit, the system further comprising:
said cams further comprising spring-loaded locking pins emplaced between the left side cam and the left side of the equipment unit casing, and between the right side cam and the right side of the equipment-unit casing, and configured to slip into depressions emplaced in the left side of the equipment casing and the right side of the equipment casing at the points of full extension of the cam;
wherein said locking pins are configured to lock said handle in place when said handle is in full vertical orientation or in full horizontal orientation.

8. A mechanical docking and latching system as recited in claim 1 for digital recording equipment comprising an equipment docking unit and a detachable equipment unit configured to provide secure interconnection and environmental hazard protection for the detachable equipment unit, the system further comprising:
Said left surface and right surface of said equipment docking unit further comprising guidance rails that are ramp-shaped;
Said guidance rails also comprising slots that engage said sliding rails of said equipment unit when said equipment unit is inserted into said equipment docking unit;
Wherein said ramp-shaped guidance rails engage the slidable protective plate thereby sliding said protective connector plate vertically to reveal said connectors emplaced within the rear surface of said equipment unit, allowing such connector to mechanically mate with said mating connector on said rear surface of the equipment docking unit;
Wherein said mechanical mating of connectors comprises secure mechanical and electrical connectivity between said equipment unit connector and said equipment docking unit mating connector.
